(19) United States
(12) Patent Application Publication
(10) Pub. No.: US 2015/0294276 A1
(43) Pub. Date: Oct. 15, 2015

(54) APPOINTMENT MANAGEMENT SYSTEM AND METHOD

(71) Applicants: LEO CHARLES VINCENT, DOLLARD-DES-ORMEAUX (CA); EDWARD PARDIAK, COTE SAINT-LUC (CA)

(72) Inventors: LEO CHARLES VINCENT, DOLLARD-DES-ORMEAUX (CA); EDWARD PARDIAK, COTE SAINT-LUC (CA)

(21) Appl. No.: 14/687,220

(22) Filed: Apr. 15, 2015

Related U.S. Application Data
(60) Provisional application No. 61/979,746, filed on Apr. 15, 2014.

(51) Int. Cl. G06Q 10/10

(52) U.S. Cl. CPC G06Q 10/1095

(57) ABSTRACT

There is disclosed an integrated appointment management system for managing appointments with a plurality of service professionals, the service professionals each associated with a different service provider. The system comprises a downloadable service professional appointment management applet for execution on a mobile communications device, a service provider portal comprising a calendar application and a data communications system for interconnecting said appointment management applet with each of said calendar application. The data communication system can be integrated to collect, store, analyze and/or carry a data stream (for example but not limited to medical, pharmacological, physiological or any other data) and designed to interface with a network of sensors, actuators and other communication devices such as but not limited to the Internet of Things (IoT) devices that are either embedded, whether portable or not. The data stream is used to facilitate an efficient interchange of information between the user and service provider.

### FIELD OF THE INVENTION

The present invention relates to an appointment management system and method.

### BACKGROUND

The prior art discloses appointment management systems which allow service provides such as doctors, dentists and the like and clients such as patients to communicate regarding the reservation, cancellation and modification of appointments and the like. One drawback of such systems is that they are limited to providing one or more clients with tools to arrange, manipulate, confirm and/or cancel appointments with a single service provider, such as a clinic or service station or the like.

As a result, service providers currently deploy significant resources and time to manage appointments and their relationship with their clients. Historically this is done through phone calls, emails and the like.

What is needed therefore, and an object of the present invention, is a system and method for booking and managing appointments including the real time tracking of appointments and confirmation management, in order to better manage and reduce services users from failing to show up for appointments. There is also a need for a data communication system integrated to collect, store, analyze and/or carry a data stream (for example but not limited to medical, pharmacological, physiological or any other data) and is designed to interface with a network of sensors, actuators and other communication devices such as but not limited to the Internet of Things (IoT), devices that are either embedded, whether portable or not. The data stream is used to facilitate an efficient interchange of information between the user and service provider.

### SUMMARY OF THE INVENTION

In order to address the above and other drawbacks, there is provided an integrated appointment management system for managing appointments of a user with a plurality of service professionals, each of the service professionals associated with a different one of a plurality of service providers. The system comprises a downloadable service professional appointment management applet for execution on a mobile communications device associated with the user, the applet for retrieving in real time an availability of a selected one of the service professionals, for transmitting in real time an appointment request with the selected service professional, an appointment confirmation with the selected service professional and a client appointment cancellation with the selected service professional and receiving in real time an appointment reminder with the selected service professional, an appointment update with the selected service professional and an appointment cancellation with the selected service professional, the applet also displaying a current status of any such appointments associated with the user, a service provider portal, the portal comprising a plurality of service provider spaces, one of each of the spaces subscribed to and accessible by a particular one of the service providers, each of the spaces comprising a calendar application indicating when the service professional associated with the particular service provider is available for an appointment with a service user, and a data communications system for interconnecting the appointment management applet with each of the calendar application.

In a particular embodiment, the data communication system can be integrated to collect, store, analyze and/or carry a stream of useful data (for example but not limited to medical, pharmacological, physiological or any other data) and is designed to interface with the use of network of sensors, actuators and other communication devices such as but not limited to the Internet of Things (IoT) devices that are either embedded, portable or not. The data stream is used to facilitate an efficient interchange of information between the user and service provider.

### BRIEF DESCRIPTION OF THE DRAWINGS

FIG. 1 provides a block diagram of an integrated appointment management system in accordance with an illustrative embodiment of the present invention;

FIGS. 2A through 2H provide screen views of a service provider portal interface for managing providing a service in accordance with an illustrative embodiment of the present invention;

FIGS. 3A though 3K provide screen views of a service user applet interface for scheduling appointments with service providers in accordance with an illustrative embodiment of the present invention;

FIGS. 4A and 4B provide screen views of a service provider portal interface for managing appointments in accordance with an illustrative embodiment of the present invention; and

FIGS. 5A through 5E provide screen views of a service provider portal interface for managing messages and advertisements for transmission to the user and in accordance with an illustrative embodiment of the present invention.

### DETAILED DESCRIPTION OF THE ILLUSTRATIVE EMBODIMENTS

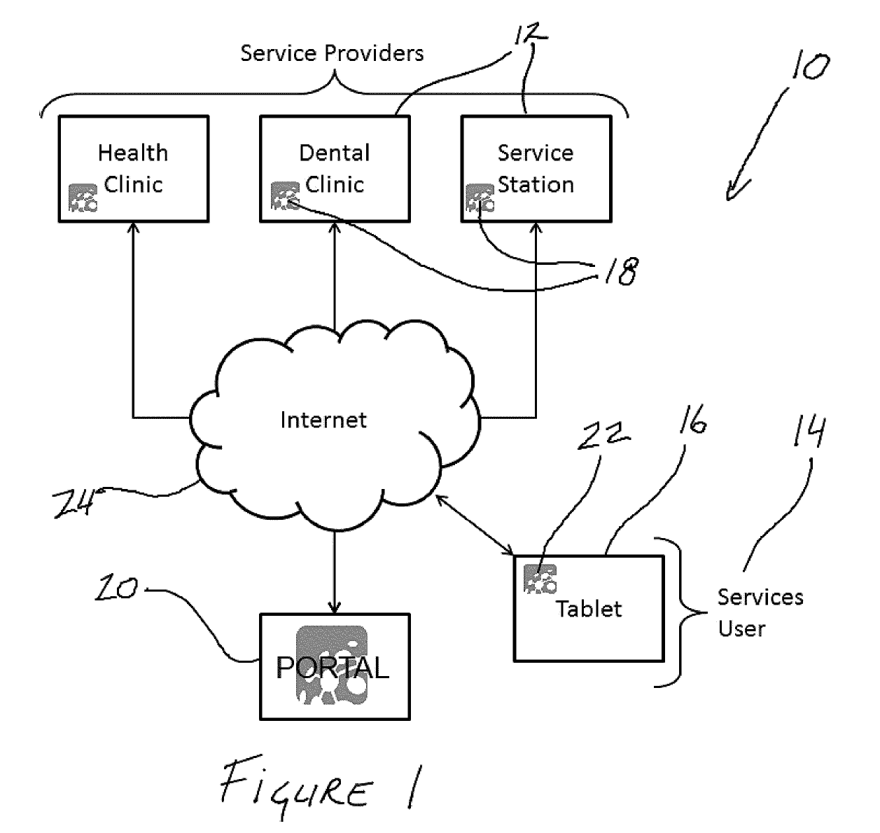

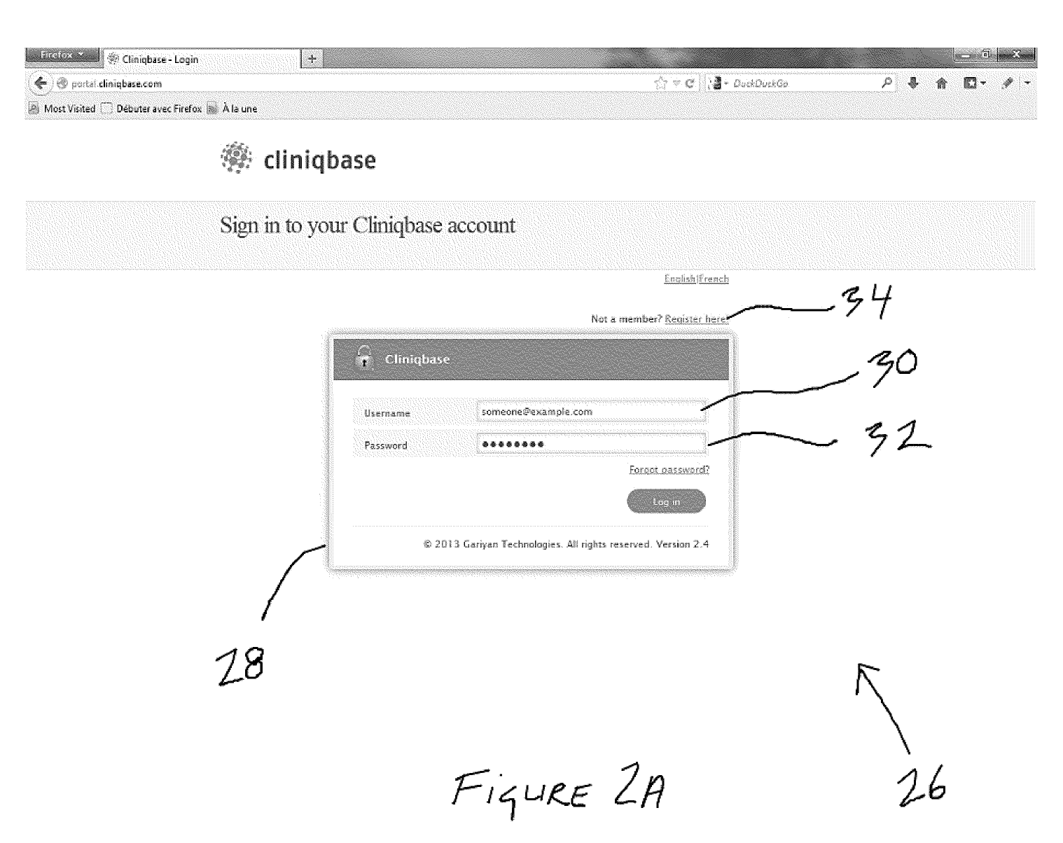

Referring now to FIG. 1, an integrated appointment management system in accordance with an illustrative embodiment of the present invention will now be described. The system, generally referred to using the reference numeral 10, comprises a plurality of service providers as in 12, such as health or dental clinic or other service providers who provide appointment based services to a services user 14 who is equipped with a portable media device 16 such as tablet or smartphone or the like. Such services comprise check-ups with a service professional such as a dentist or doctor, inspections with a mechanic or the like or other procedures typically offered by such service professionals or mechanics and for which an appointment is required. Indeed, in general the system is suitable for use by a variety of service providers such as physicians, dentists, physiotherapists, chiropractors, diagnostic centers, pharmacies, lawyers, car dealers, garages, hair dressers, home delivery services, utility technicians, electricians, plumbers, fitness instructors, coaches, etc.

Still referring to FIG. 1, using a web browser 18, service providers communicate with a service provider portal 20 which in turn communicates with an appointment applet 22 installed on the services user's portable media device 16 via a broadband network such as the Internet 24. The service provider portal 20 can be a web server or the like and reachable via the Internet 24 by a Uniform Resource Locator (URL) or the like.

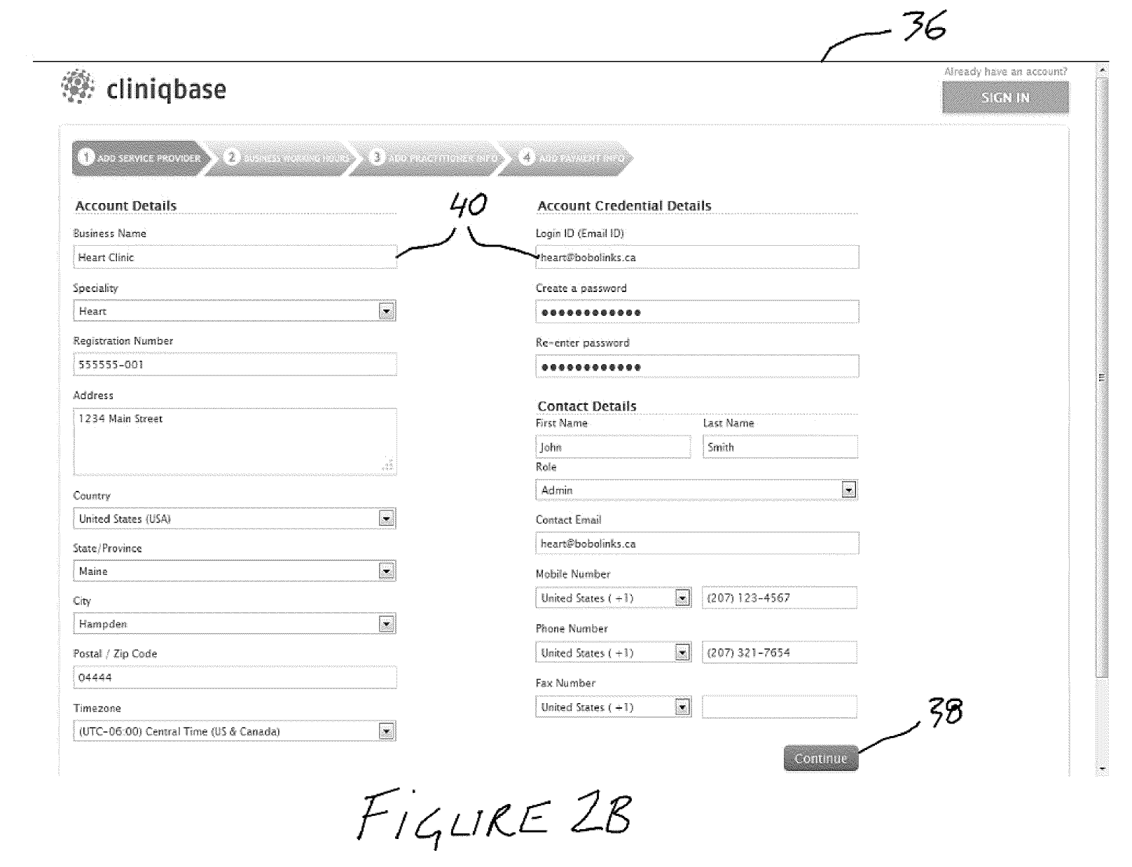

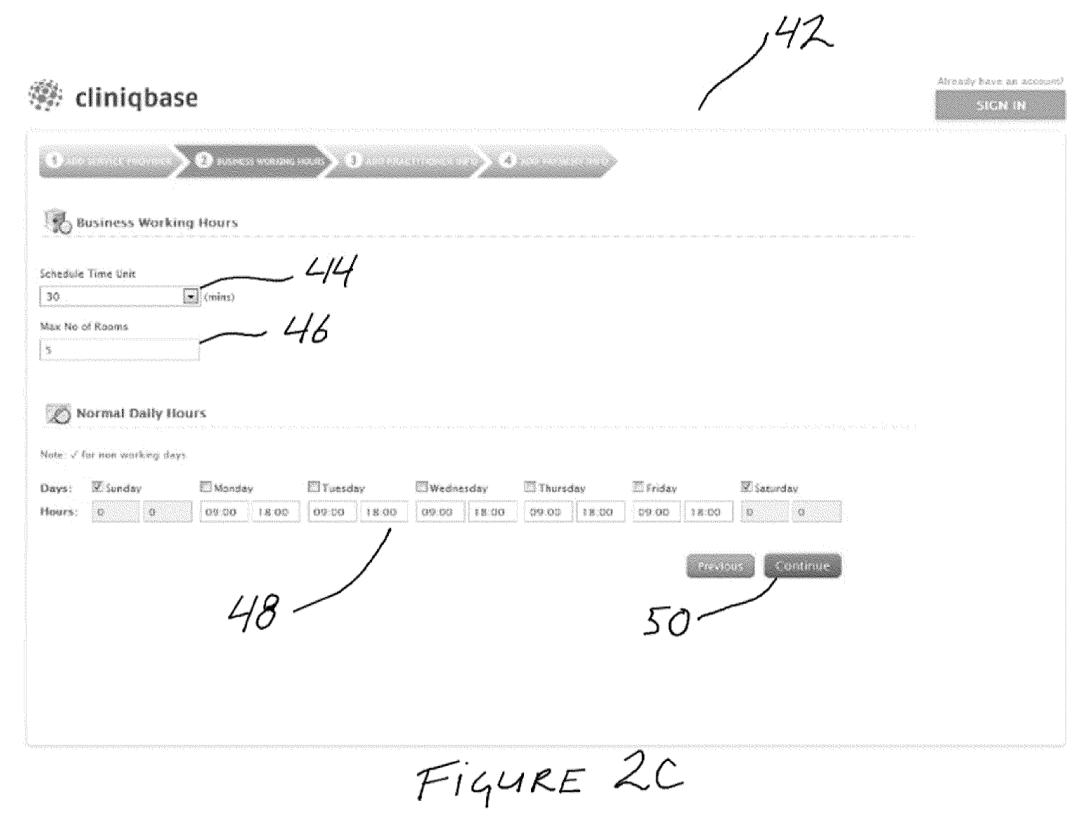

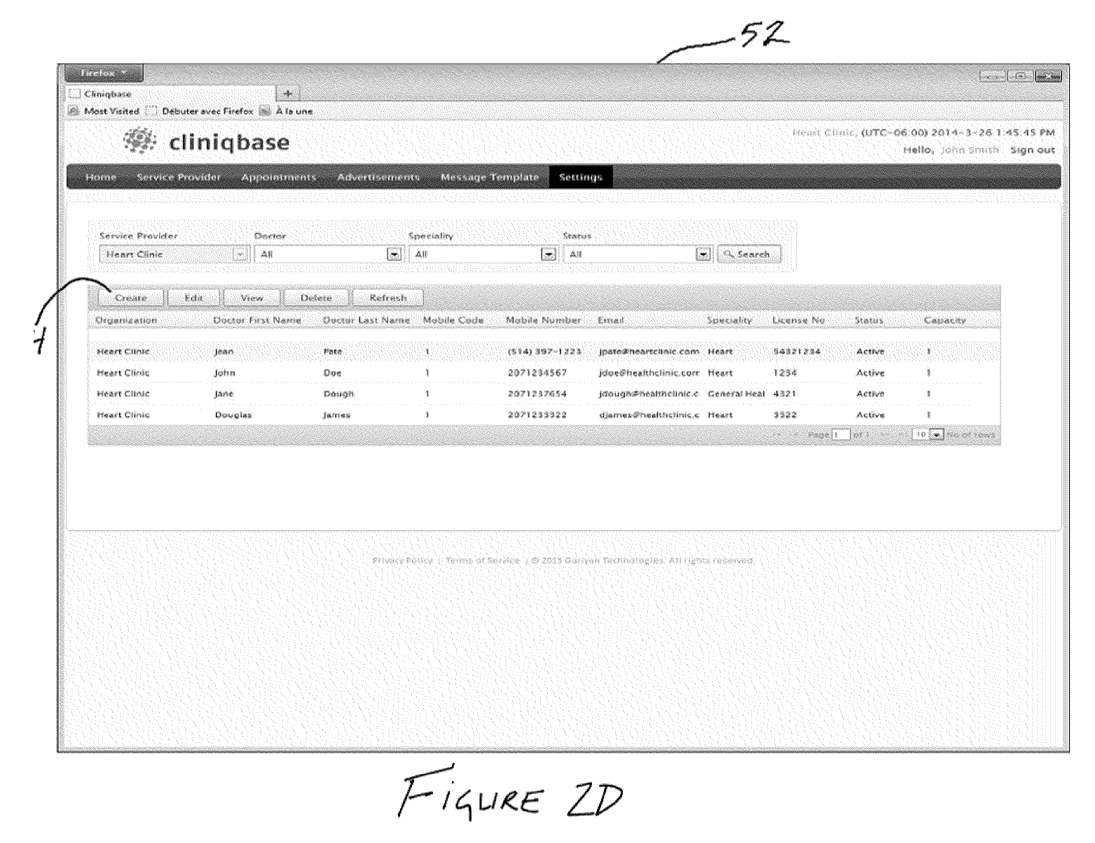

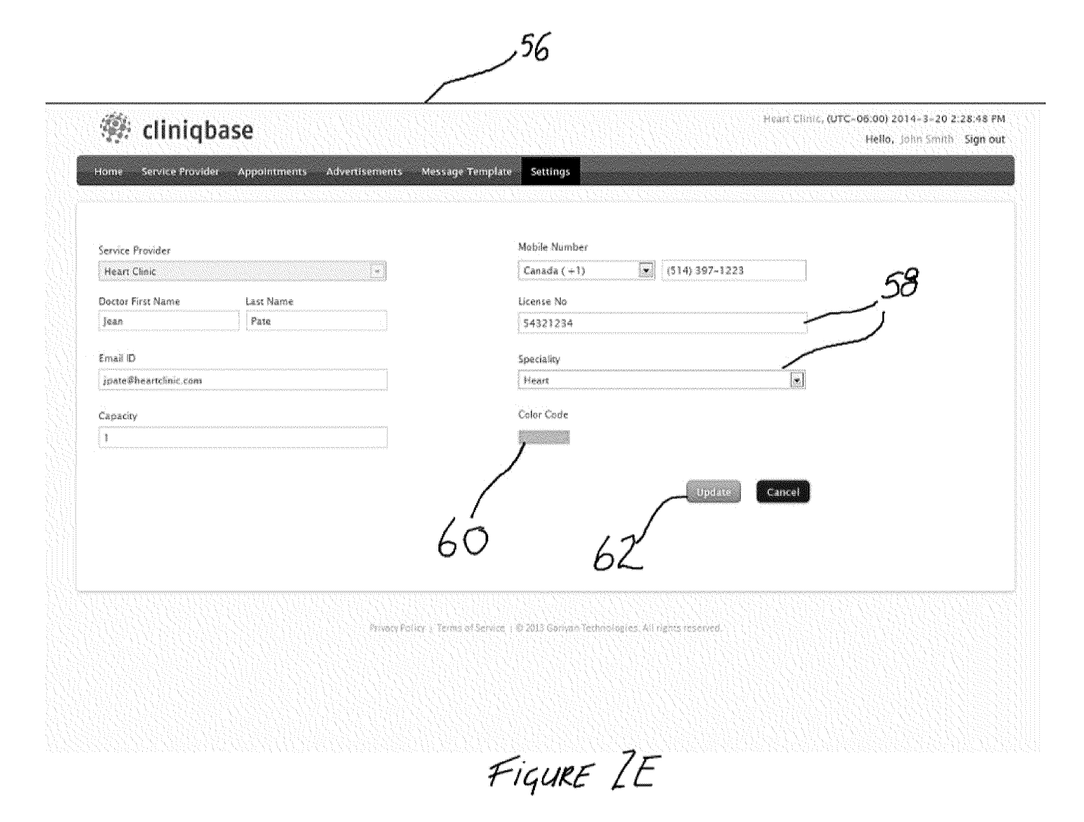

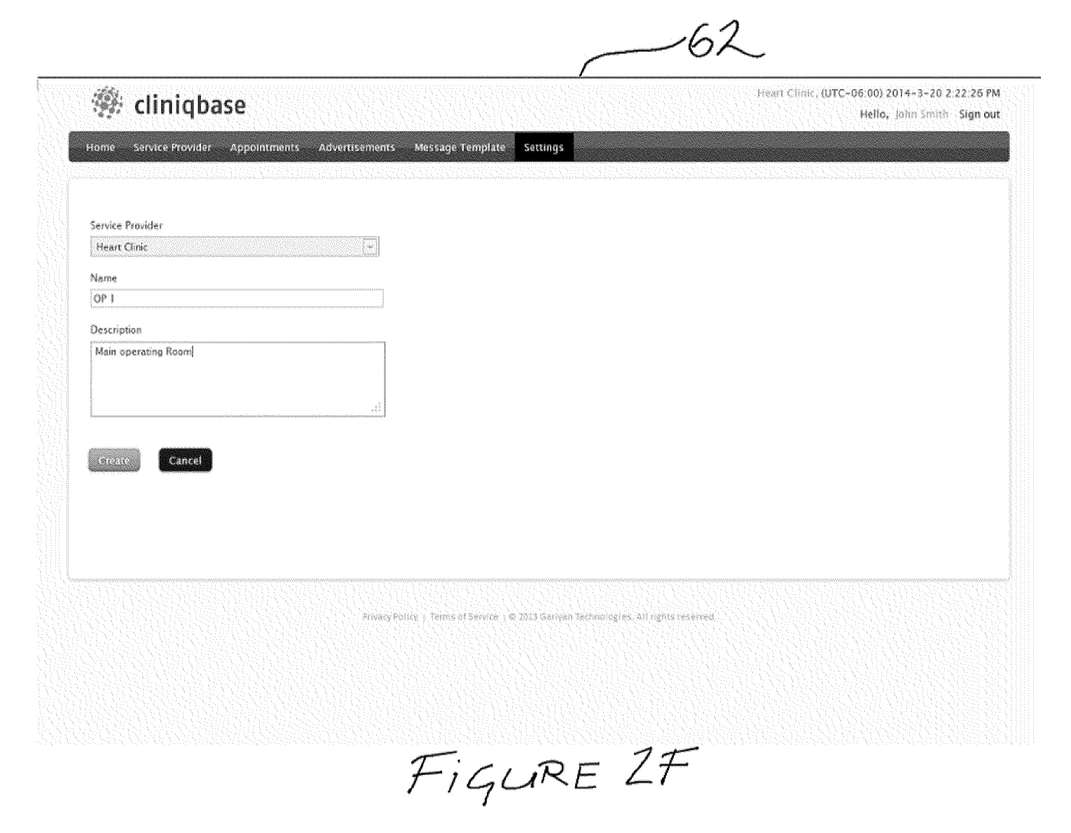

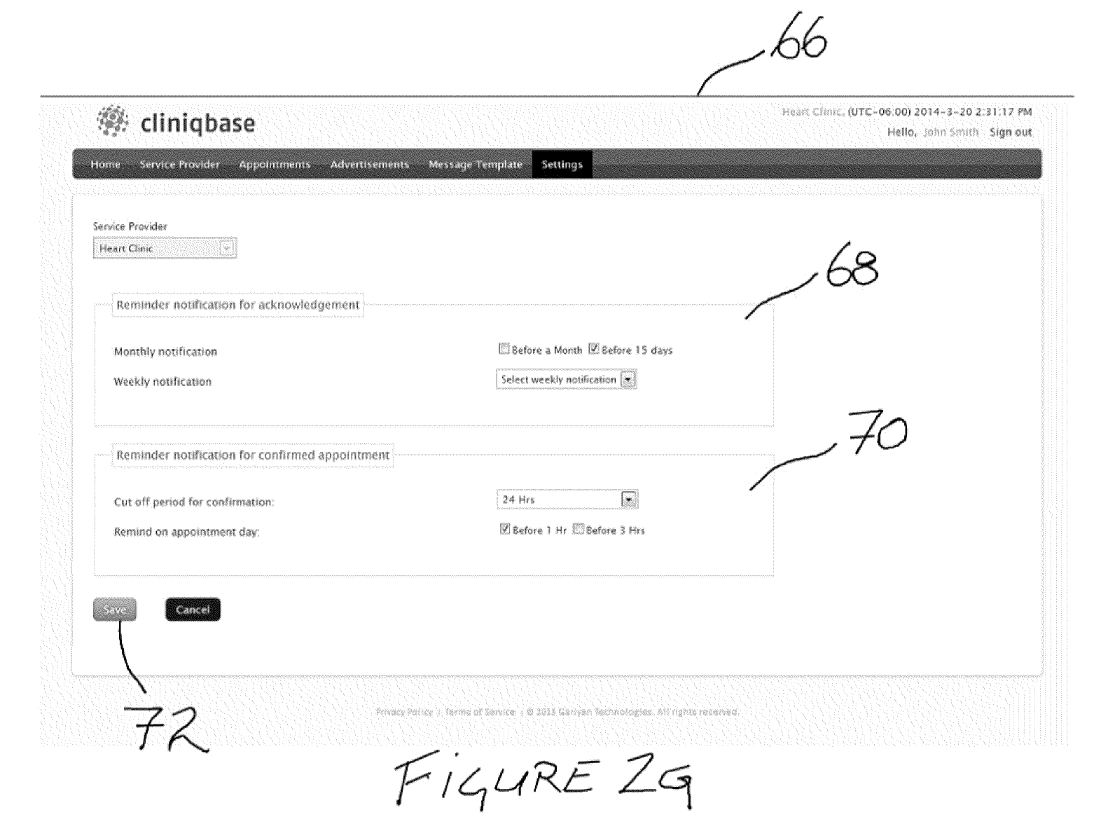

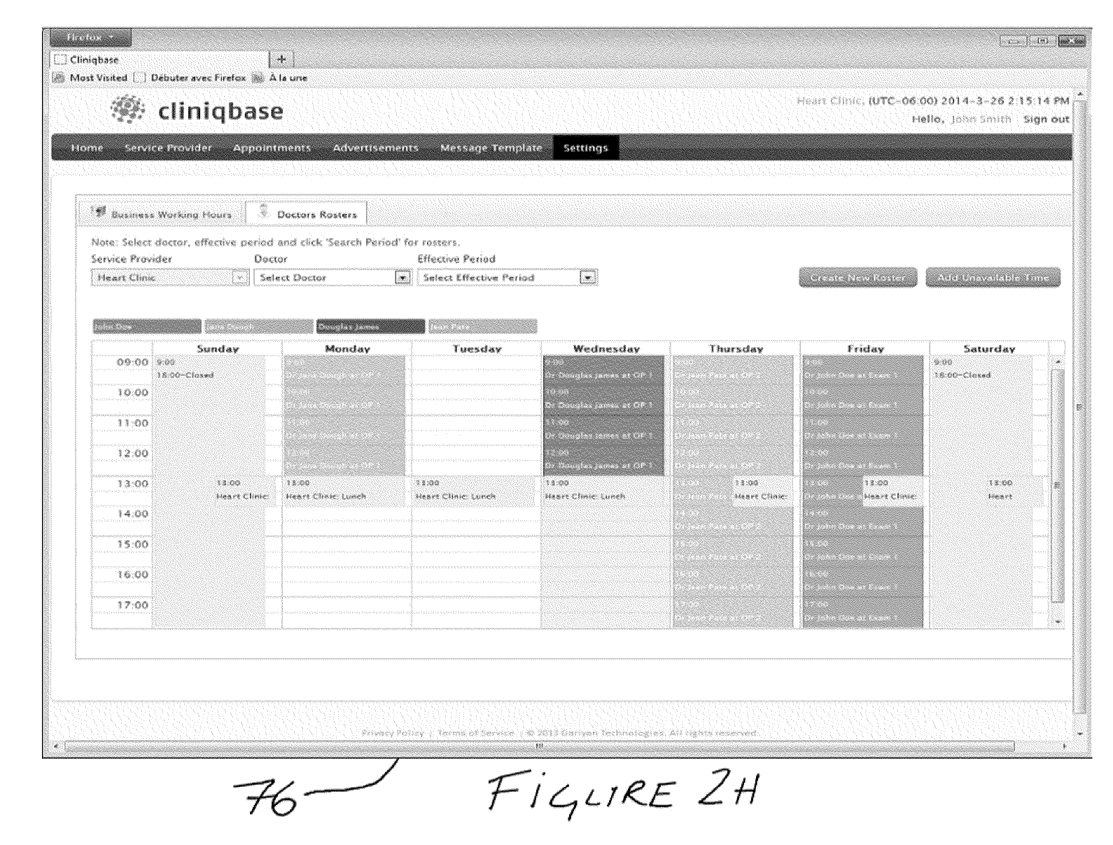

Referring to FIG. 2A, in order to participate in the appointment management system the service provider migrates to the service provider portal 20 by using an appropriate URL (in the example case portal.cliniqbase.com) where the service provider is presented with a log on screen 26 which includes a logon dialog box 28. The service provider logs on to the portal by entering his unique user id 30 (typically an email address or the like) and password 32. In the event the service provider has not already done so, the service provider can register an account and become a member by selecting the register link 34.

Referring to FIG. 2B in addition to FIG. 2A, by selecting the register link the service provider migrates to an account details screen 36 where information regarding the service business such as address, contact persons and the like as well as user credentials can be entered and saved. In the illustrative embodiment the service provider is a heart clinic and registers as such.

Referring to FIG. 2C in addition to FIG. 2B, following entry of the appropriate data account details screen 36, by selecting the continue button 38 data entered into the various text fields 40 is saved and the service provider migrates to the business working hours screen 42. The business working hours screen 42 allows the service provider to set a typical service slot duration 44, the maximum number of rooms, service bays or the like 46 which can be scheduled during a given slot as well as normal daily opening hours 48 for the clinic or service center.

Referring to FIG. 2D in addition to FIG. 2C, on selection of the continue button 50 the service provider migrates to the practitioner's screen 52. The practitioner's screen 52 allows the service provider to create, view and edit the practitioners or service practitioners who will subsequently be allocated to clients such as patients. Referring to FIG. 2E in addition to FIG. 2D, selecting the create button 54 on the practitioners screen 52 opens up the practitioners dialog 56 where the service provider can enter details about each practitioner in the provided text fields as in 58. Additionally, a color code 60 can be assigned to each practitioner such that, as will be discussed in more detail below, they can be easily recognized on calendars and the like (not shown). The created practitioner can be added to the list of existing practitioners by selecting the update button 62.

Referring now to FIG. 2F, migration to the room settings dialog 64 allows the service provider to create and edit rooms or service bays which can be used by the practitioner when providing appointment based services to a patient or other client.

Referring now to FIG. 2G, migration to the notifications settings dialog 66 allows the service provider to select default settings for reminders to be sent to clients regarding scheduled appointments 68 with service providers as well as cut-off dates for cancelling appointments 70. Selection of the save button 72 stores the default settings.

Once practitioners and rooms have been created using the above dialogs, rosters can then be developed by selecting the appropriate roster and scheduling item from the settings menu. Referring to FIG. 2H, selection of this item opens a calendar dialog 76. The service provider can then plan the service practitioners into time slots and assign them to examination rooms or service bays or the like.

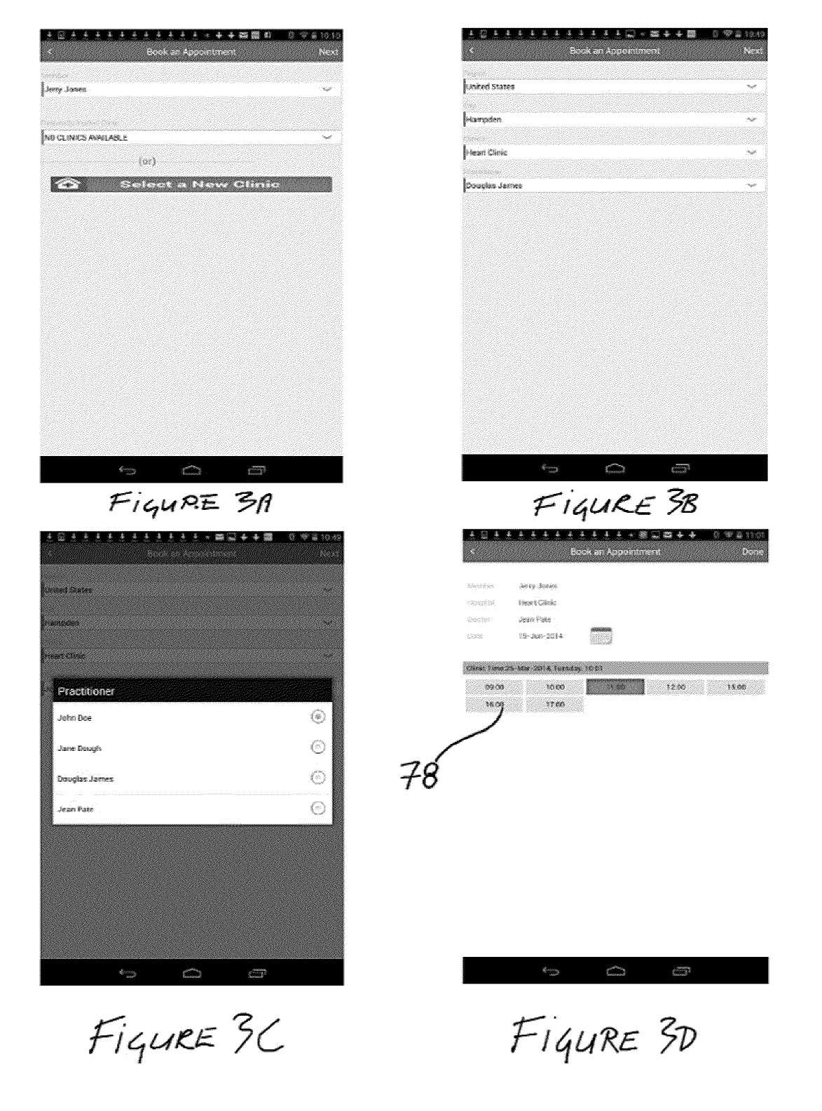

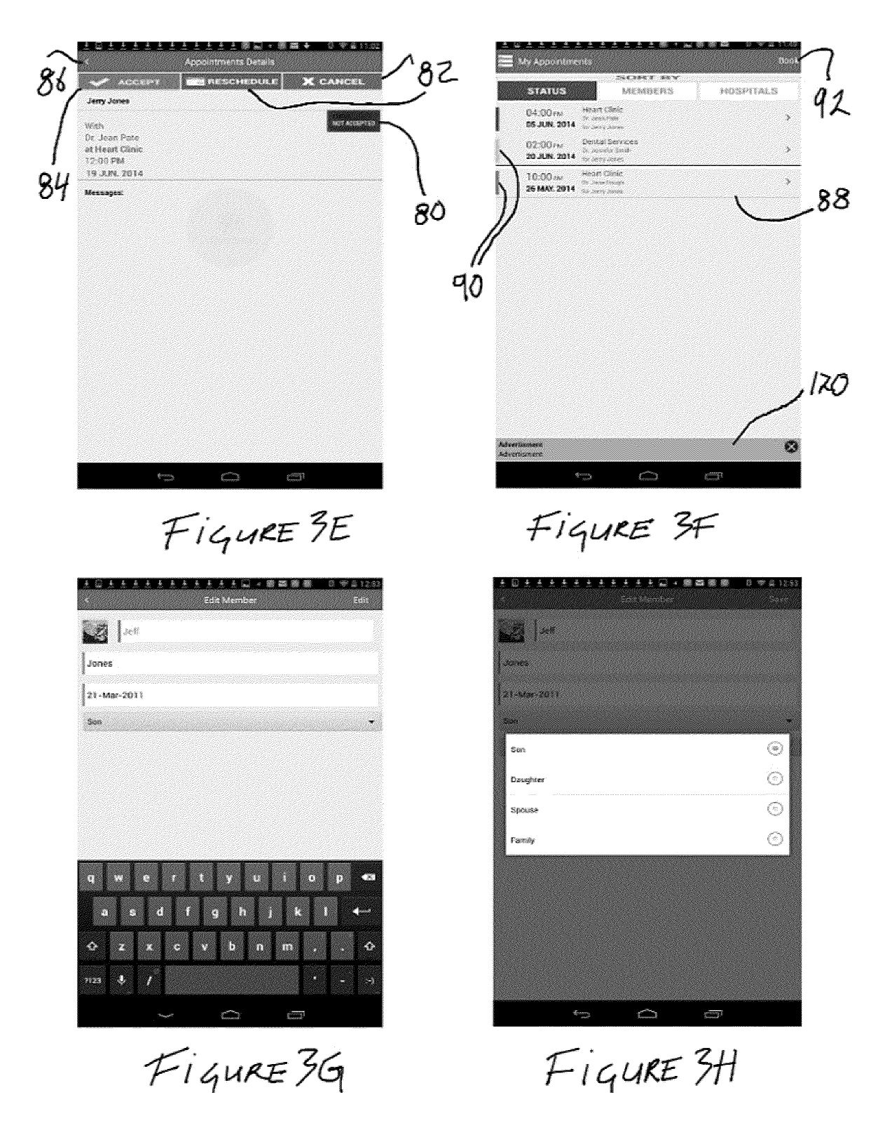

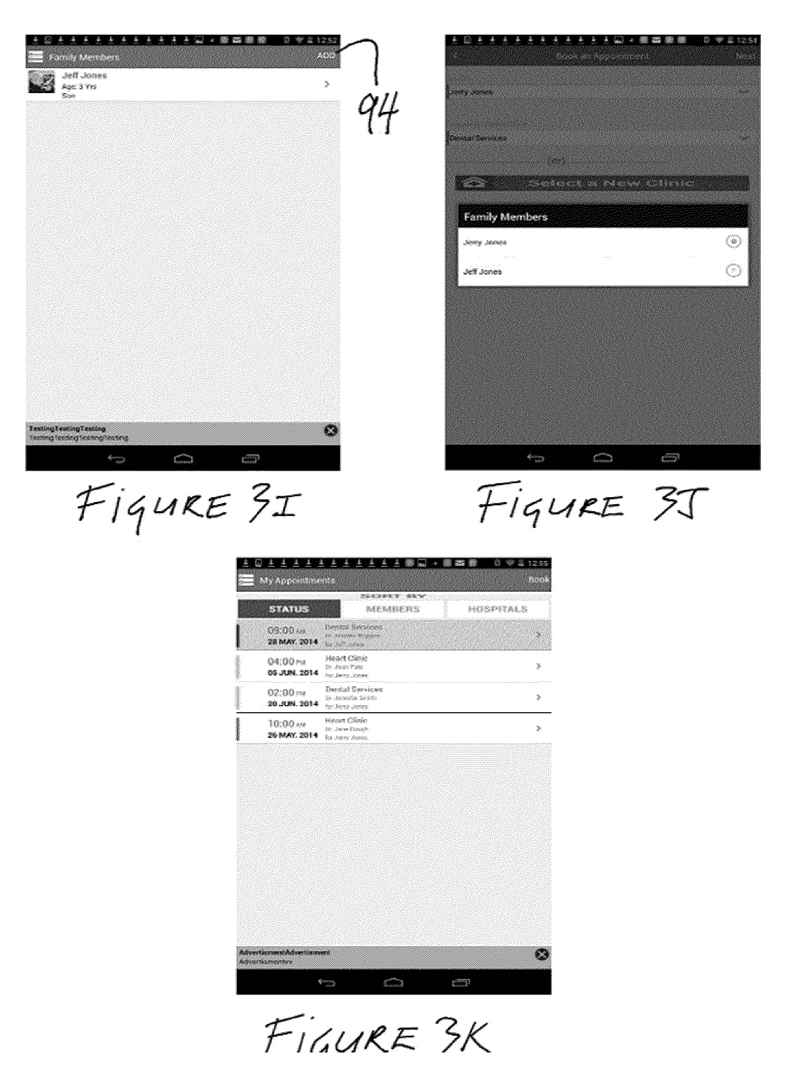

Referring now to FIG. 3A in addition to FIG. 1, once the practitioners have been planned into time slots during a particular time period (typically several weeks or months) via the service provider portal 20, using a client device 16, such as tablet or smart phone or the like, the services user 14 may log onto the portal 20 using the appointment applet 22. Referring to FIG. 3B, using the applet 22 the services user 14 can select from service providers and practitioners by country, city, clinic or practitioner. Particular fields can be selected by appropriate tapping on the screen (not shown) of the tablet or smartphone 16. Referring to FIG. 3C, selecting the practitioner field together with a given clinic, for example, provides the services user with a selectable list of practitioners who are available for providing services at that clinic. The services user is presented with a calendar (not shown) providing future dates when the service professional is available for an appointment and from which he can select a mutually convenient date. Referring to FIG. 3D, appointments can be booked only for those days and time slots 78 for which a practitioner is available and not already providing services to another service user.

Referring now to FIG. 3E in addition to FIG. 3D, once the user selects a time slot 78 the appointment details are presented to the services user. Illustratively, the appointment is associated with a colour coded icon 80 to indicate its status. For example, if the appointment has yet to be established, it is colour coded with a red icon. Yellow is illustratively used to indicate that the appointment has been accepted but not confirmed, and green is illustratively used to indicate that the appointment has been both accepted and confirmed. Additionally, the appointment applet 22 provides services user 14 with appropriate icons as in 82 to accept, reschedule or cancel the appointment. The services user can choose to accept the appointment by selecting the accept icon 84. The event is also created in the device's calendar, and with which the appointment applet 22 is integrated. Similarly, rescheduling or cancelling of an appointment is also reflected by a similar modification to the device's calendar. Alternatively, the services user can elect to not accept the appointment by selecting the “Back” item 86.

Referring back to FIG. 2G in addition to FIG. 3E, alternatively an appointment may be scheduled by the service provider via the portal, following which the user/patient is notified as a new appointment in the appointment applet 22 and initially listed with the color code ‘Red’. In any case, if the user fails to accept the appointment, then the reminder settings are engaged and the user is requested to accept or cancel the appointment. Reminders are sent according to the selected notification period(s). Additionally the entry remains flagged red in the appointment applet 22 until the user/patient accepts, reschedules or cancels the appointment. As the current date approaches the date of the scheduled appointment and the user has still failed to accept and/or confirm the appointment, this status is flagged to the service provider so he can take remedial action, such as cancelling the appointment.

Referring now to FIG. 3F, subsequently the services user 14 is presented with a list 88 of his/her appointments. The appointments are conveniently coded using a coloured flagging as in 90, providing an indication of the current status of the appointment, as discussed above not accepted (red), accepted but not confirmed (yellow) and confirmed (green). A person of ordinary skill in the art will understand that other colours or coding (for example, using appropriate icons or the like) could be used to indicate status in a given embodiment. Additional appointments can be scheduled with the same or other service providers 12 by selecting the “Book” item 92.

Referring now to FIG. 3G, in addition to appointments for his-/herself, the services user may also book and manage appointments for one or more other individuals (illustratively family members such as son, daughter or spouse). In order to do this the family member is first added by providing identifying information such as name and date of birth as well as the relationship to the services user who is registered for the account (FIG. 3H) and then, with reference to FIG. 3I, adding the new family member by selecting the “Add” item 94. With reference to FIG. 3J, subsequently when booking appointments, the service user 14 may select one of these family members, which will then be user instead of the services user for booking the appointment. With reference now to FIG. 3K, once an appointment has been booked for the particular family member, the appointment appears together with those of other family members and/or those of the services user who has registered the account.

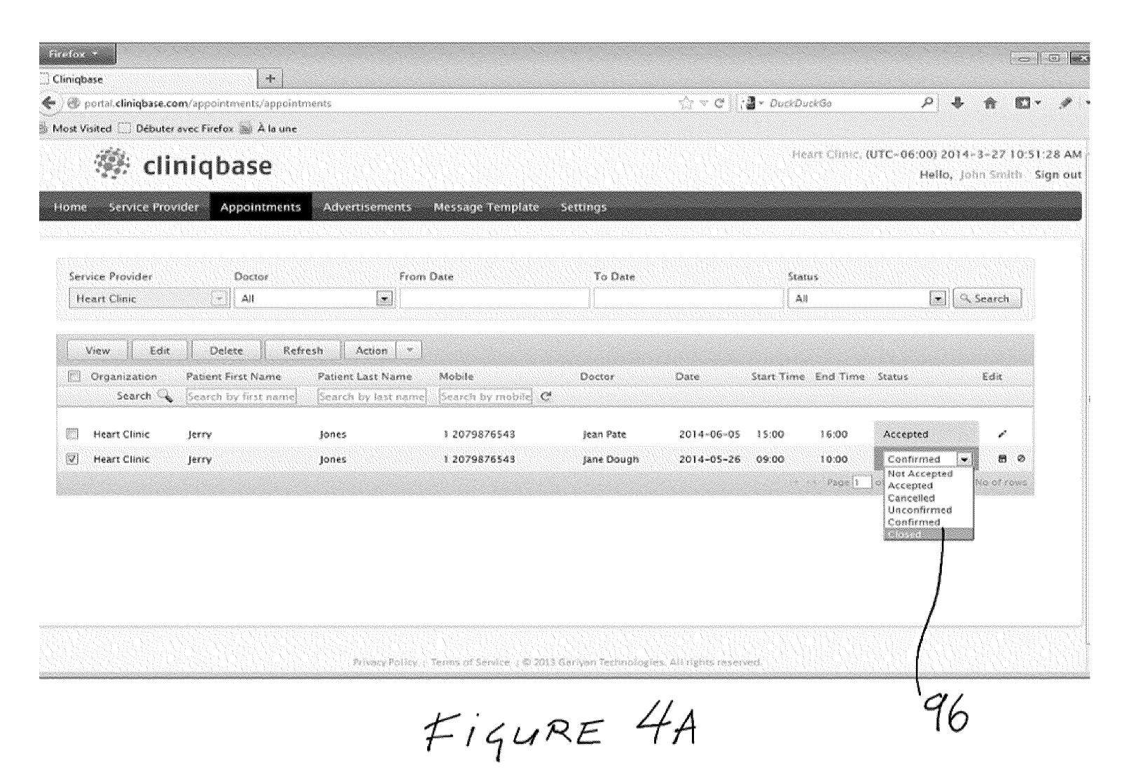

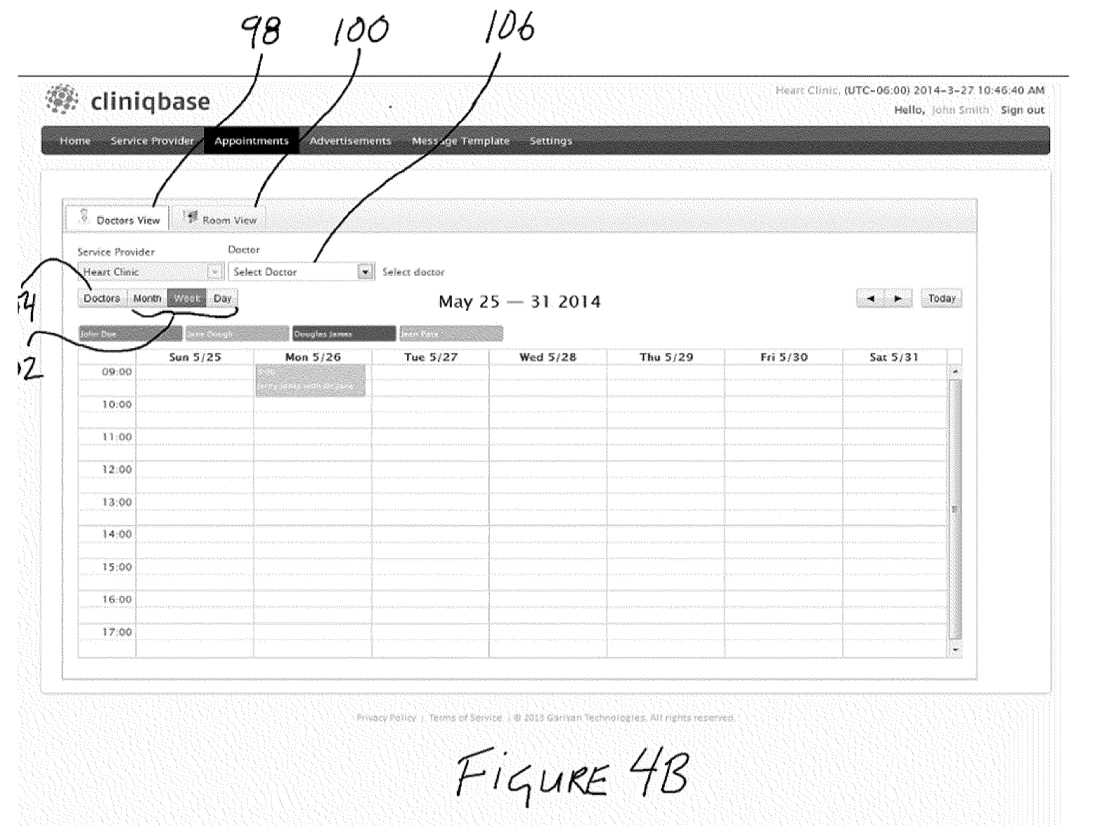

With reference to FIGS. 4A and 4B, by logging into his service provider account via the portal 20, the service provider can view appointments for its roster of professionals in both a grid view (FIG. 4A) and a calendar view (FIG. 4B). In the grid view (FIG. 4A) the service provider can view pending appointments scheduled with one or other of the service professionals as well as their current status of not accepted, accepted and confirmed. Using a drop down box 96, the service provider can manually modify the current status of the appointment, for example in order to cancel the appointment such that it can be rescheduled, or the like. In the calendar view (FIG. 4B), the service provider can view upcoming appoints for one or all service professionals by selecting the Doctors View tab 98 or the room allocation by selecting the Room View tab 100. The calendar view of FIG. 4B can be provided in a variety of formats, including daily, weekly, or monthly by selecting the appropriate day, week or month button as in 102. Alternatively, the calendar view can be generated per doctor (not shown) by selecting the Doctors button 104. Additionally, for each calendar view, the calendars of each individual service professional may be viewed via the Select Doctor drop down box 106.

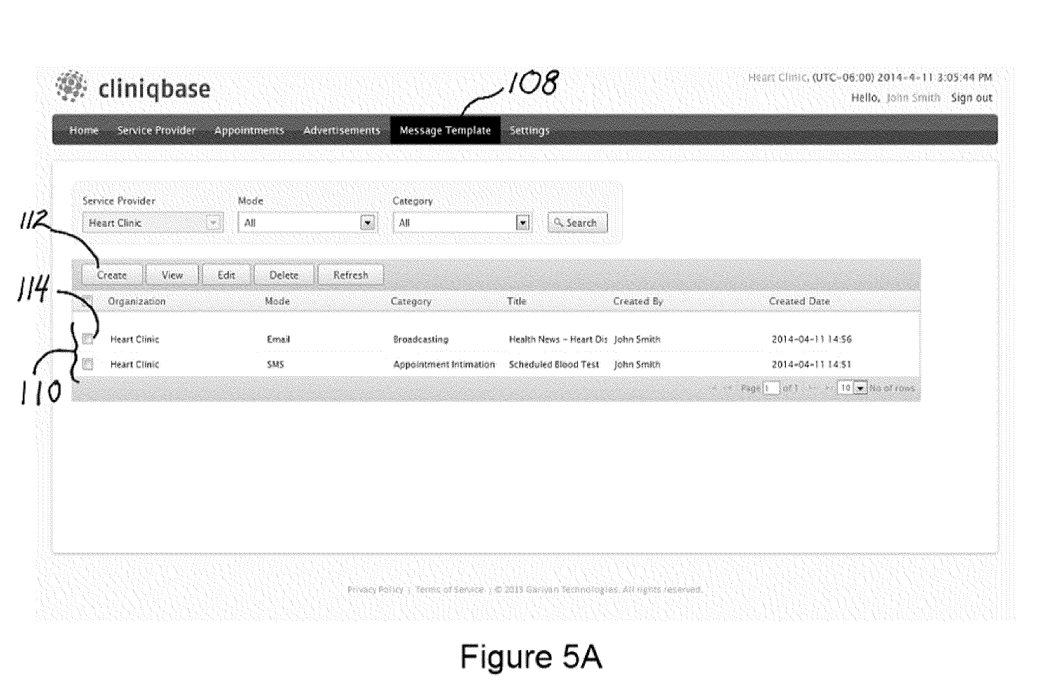

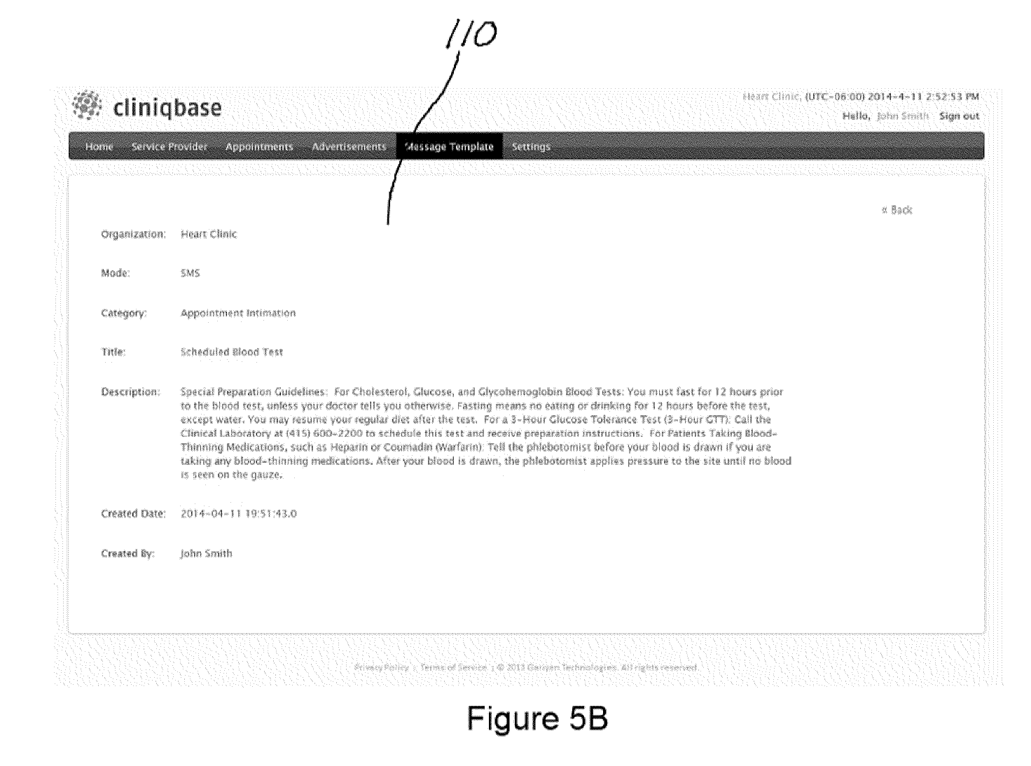

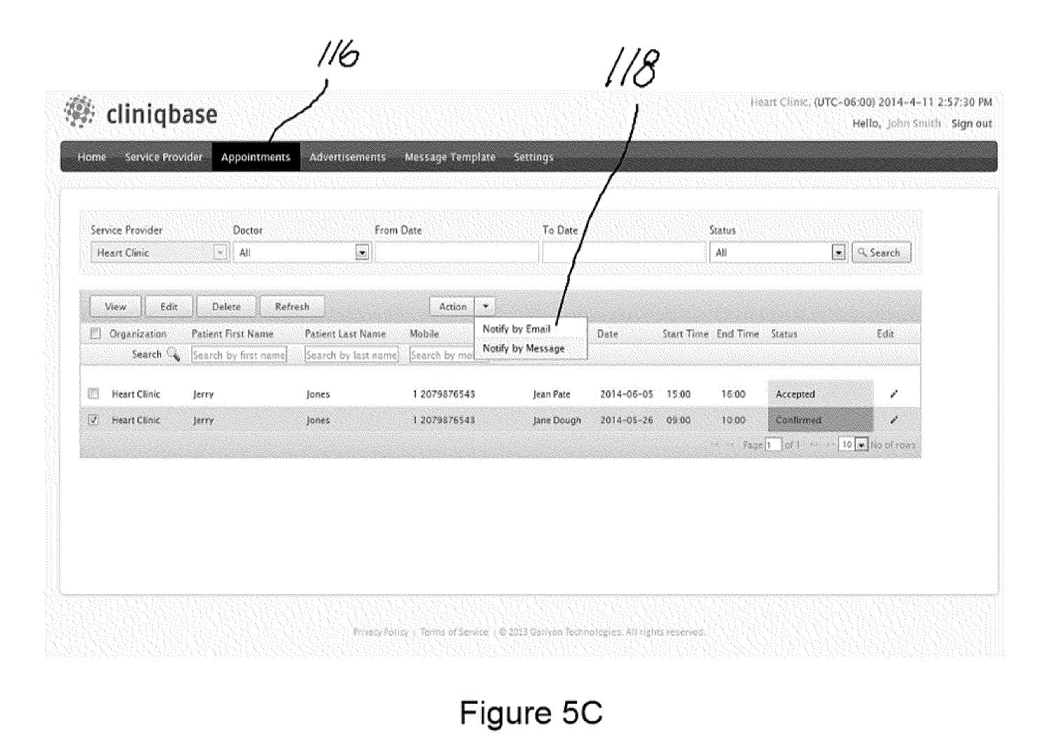

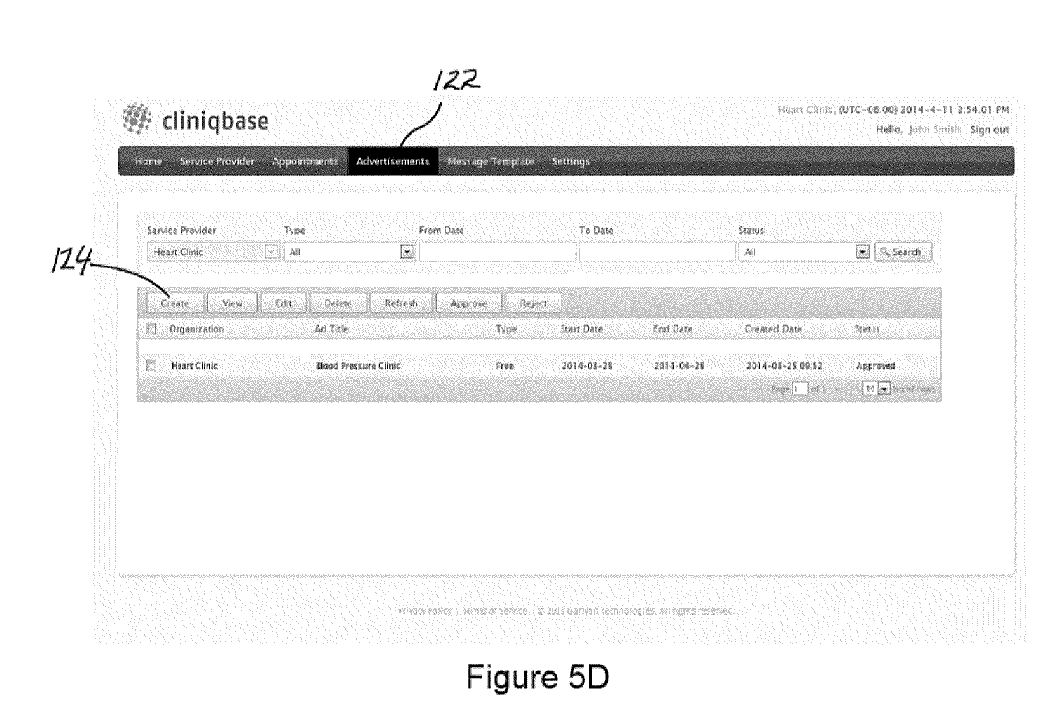

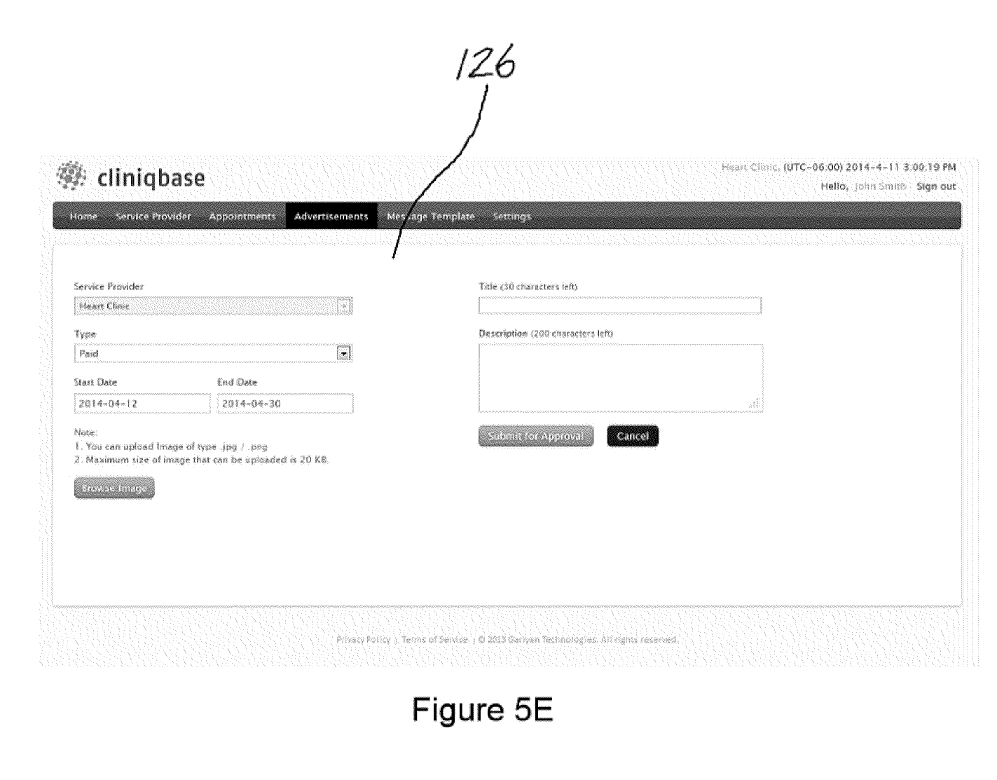

Referring now to FIG. 5A, in addition to scheduling appointments and the like, the system as disclosed provides a convenient means for the service provider to direct messages to one or more users. For example, for particular types of procedures it is typically useful to inform the user/patient prior to the appointment of any preparatory steps he should undertake or whether or not particular items or documents or the like should be brought by the user at the time of the appointment. By selecting message template 108 from the portal menu the service provider is presented with one or more prepared messages 110 which can be sent to the user(s). New messages can be created by selecting create 112 and previously created messages viewed by selecting the check box 114 adjacent the given message and selecting view which, referring now to FIG. 5B, opens the message 110. In addition to the above, and in a particular embodiment, the data system can be integrated to collect, store, analyze and/or carry a data stream (for example but not limited to medical, pharmacological, physiological or any other data) and is designed to interface with the use of network of sensors, actuators and other communication devices such as but not limited to the Internet of Things (IoT) devices that are either embedded, portable or not. The data stream is used to facilitate an efficient interchange of information between the user and service provider.

Referring now to FIG. 5C, by selecting the Appointments menu item 116 the service provider can view upcoming scheduled appointments and send messages to one or more users who have scheduled appointments by selecting the user(s) and action 118, which allows the service provider to distribute the message to the selected user(s) via a selected notification means, such as SMS, e-mail or the like.

Referring back to FIG. 3F, a banner 120 is provided illustratively at the bottom of the applet 22 via which the service provider can publish advertisements or the like which are displayed to the user.

Referring to FIG. 5D, advertisements can be created viewed, edited or deleted by selecting advertisements 122 from the menu. In order to create a new message, create 124 is selected which, referring to FIG. 5E, presents each service provider with an advertisement preparation screen 126 via which they can prepare advertisements for exclusive transmission to their users. Various fields are provided in order to allow the service provider to enter the content of the advertisement, such as text and images, and also to schedule the type (paid or free) as well as the time period/dates within which the advertisement should be circulated. Service providers can therefore leverage this functionality for advertising their services, or new initiatives or the like. For example if a physiotherapy clinic organizes a pain clinic for a specific day, then they can use this feature to advertise the event. Likewise, if an automobile service station is running a campaign for engine checkups, oil changes or seasonal tire changes or the like, this can be advertised using the advertising field.

In an alternative embodiment, appointment times are dictated solely by the clinic and for example using the calendar view of FIG. 4B. In this regard, appointments are pushed to the appointment applet 22 on the user's device 16, and such that the user can accept the user or not accept the proposed appointment, request rescheduling of the proposed appointment, or cancel an appointment, for example via the appointment details screen of FIG. 3E. Requests for rescheduling can be placed, for example, in a waitlist or the like, and a user notified automatically of an appointment time which becomes available due to another cancellation, the addition of doctor availability or the like. In a particular embodiment a user is offered one or more additional preferred appointment times available on payment of a fee. Likewise alternative appointment times may be offered at a discounted rate.

Both the applet 16 and the web portal 20 in a particular embodiment may be compatible with Biometric or Gesture Recognition Technology (GRT) and such that a user might perform an action, for example requesting a new appointment, cancellation, confirmation, etc. through the use of appropriate gestures. In a particular embodiment, and to improve the security of data and system operation the system illustratively supports the use of biometric data. In a particular embodiment data can also be encrypted to reduce its vulnerability to copying and misuse.

The system 10 is not limited to use with health professionals but may also find broader use in the context of garages, for example to organise car pick service during maintenance, car dealerships, hair and beauty salons, spas, etc.

In a particular embodiment, for example in a system which issued for scheduling car service, garages, car dealerships or the like, the system may be integrated with the Enterprise Resource Planning (ERP)/supply chain management or spares management system to fetch the information from such systems for display in the applet 22. For example, if a user books an appointment for a tire change via the applet 22, the applet 22 may also provide the ability to search inventory for tires and their respective prices for display to the user. As a result, the system 10 with mobile applet 22 will enhance the entire supply chain process.

Additionally, the system 10 may be integrated with service providers, for example the yellow pages, YELP or the like, which will help potential users to find the required services and book such services via the applet 22. For example, the yellow pages currently only provide static information about a business, such as name, address, phone number and the business hours. Through integration with such service providers, the system 10 as described herein introduces the ability to collaborate dynamically with such service providers by booking an appointment or communicating with the service providers for a quote, etc. The system 10 may also include data stream management (for example but not limited to pharmacology, medical, health and fitness applications), navigation or emergency location & alert functions, integration of internet of things technology (IoT) such as smartwatches, Scanadu type devices and the like. It may also be integrated into a Bloomberg style information platform at the physician's end, for chart(less) integration and sharing between physicians. In a particular embodiment, the data communication system can be integrated to collect, store, analyze and/or carry a data stream (for example but not limited to medical, pharmacological, physiological or any other data) and is designed to interface with the use of network of sensors, actuators and other communication devices such as but not limited to the Internet of Things (IoT) devices that are either embedded, portable or not. The data stream is used to facilitate an efficient interchange of information between the user and service provider.

Although the present invention has been described hereinabove by way of specific embodiments thereof, it can be modified, without departing from the spirit and nature of the subject invention as defined in the appended claims.

We claim:

1. An integrated appointment management system for managing appointments of a user with a plurality of service professionals, each of the service professionals associated with a different one of a plurality of service providers, comprising:
a downloadable service professional appointment management applet for execution on a mobile communications device associated with the user, said applet for retrieving in real time an availability of a selected one of the service professionals, for transmitting in real time an appointment request with the selected service professional, an appointment confirmation with the selected service professional and a client appointment cancellation with the selected service professional and receiving in real time an appointment reminder with the selected service professional, an appointment update with the selected service professional and an appointment cancellation with the selected service professional, said applet also displaying a current status of any such appointments associated with the user;
a service provider portal, said portal comprising a plurality of service provider spaces, one of each of said spaces subscribed to and accessible by a particular one of the service providers, each of said spaces comprising a calendar application indicating when the service professional associated with the particular service provider is available for an appointment with a service user; and
a data communications system for interconnecting said appointment management applet with each of said calendar application.
